(19) United States
(12) Patent Application Publication
(10) Pub. No.: US 2004/0148930 A1
(43) Pub. Date: Aug. 5, 2004

(54) Combination of master cylinder device with brake booster device

(75) Inventors: Katsuhiro Mita, Gamagourl-shi (JP); Tomoo Ogura, Aichi-ken (JP)

Correspondence Address: BURNS DOANE SWECKER & MATHIS L L P, POST OFFICE BOX 1404, ALEXANDRIA, VA, 22313-1404, US

(73) Assignee: ADVICS CO., LTD.

(21) Appl. No.: 10/759,255

(22) Filed: Jan. 20, 2004

(30) Foreign Application Priority Data
Jan. 31, 2003 (JP) 2003-23145

(51) Int. Cl. B60T 13/00

(52) U.S. Cl. 60/547.1

(57) ABSTRACT

A master cylinder device connected with a brake booster device of an input rod pulling type is disclosed. In the brake booster device, the interior of a brake booster is partitioned by a diaphragm with a piston secured thereto, into a constant pressure chamber and a variable pressure chamber. The piston incorporates therein a valve mechanism operated by a brake pedal for making the variable pressure chamber communicate selectively with the atmosphere and the constant pressure chamber. The brake booster device transmits the axial movement of the diaphragm generated based on the pressure difference between the both chambers, from the piston through a reaction mechanism to an output rod. The output rod pulls a piston rod of a master cylinder rearward for making the master cylinder generate a braking pressure. The output rod extends as the piston rod in the master cylinder of the master cylinder device, and a master piston is mounted on the forward end portion of the piston rod so that it is floatable relative to the piston rod, but is restrained from being moved forward relative to the piston rod in the axial direction of the same. Thus, the master piston can be prevented from scraping against the master cylinder.

### INCORPORATION BY REFERENCE

This application is based on and claims priority under 35 U.S.C. sctn. 119 with respect to Japanese Application No. 2003-23145 filed on Jan. 31, 2003, the entire content of which is incorporated herein by reference.

### BACKGROUND OF THE INVENTION

1. Field of the Invention

The present invention relates to a master cylinder device with a brake booster device and more particularly, to a combination of a master cylinder device with a brake booster device of the type that generates pressurized braking fluid by pulling an input rod of the booster device.

2. Discussion of the Related Art

Heretofore, as described in Japanese unexamined, published patent application No. 2001-294138, there has been known a master cylinder device with a brake booster device of the type that generates pressurized braking fluid by pulling an input rod of the booster device in order to prevent a brake pedal from jumping up toward the driver at the time of vehicle collision. In the known master cylinder device, the brake booster device is installed on one surface facing an engine room of a dashboard which partitions the engine room from a passenger room. The booster device is connected with a master cylinder device having a master cylinder, and a first master piston is inserted into a forward end portion of the master cylinder. A second master piston is inserted into a rear end portion spaced from the first master piston of the master cylinder. A piston rod connected to the first master piston passes through the second master piston and is protruded from the rear end wall of the master cylinder to be operated by the brake booster device. A brake pedal arm is pivotably carried at its mid portion on a pedal bracket, which is secured to the other surface facing the passenger room of the dashboard. The brake pedal pivotably carries at its upper end a pull or input rod connected to a valve mechanism of the brake booster device and is provided with a pedal step plate at its lower end.

In the aforementioned combination of the master cylinder device with the brake booster device of the input rod pulling type, if an output rod of the brake booster device and the piston rod of the master cylinder device are provided as independent members, they would be hidden in the devices when brought into connection, and it would become difficult to connect the output rod of the brake booster device with the piston rod of the master cylinder. Thus, it is presumed that in the aforementioned brake booster device, the output rod and the piston rod are made bodily as a single member. Generally, brake booster devices are of the construction that the interior of a brake booster is partitioned by a diaphragm into a constant pressure chamber and a variable pressure chamber and that a valve mechanism is operated by an input rod to switch the variable pressure chamber into communication with the atmosphere or into communication with the constant pressure chamber so that the diaphragm is moved to advance or retract the output rod. For the reason of such construction, the output rod is swung or tilted slightly as it is moved back and forth. Thus, there arises a problem that the swing or tilting motion of the output rod which serves as a piston rod of the master brake device causes the first master piston bodily formed at the front end of the piston rod to scrape against the master cylinder, so that the master piston cannot slide smoothly thereby to increase the sliding resistance.

### SUMMARY OF THE INVENTION

Accordingly, it is a primary object of the present invention to provide an improved combination of a master cylinder device with a booster device of an input rod pulling type which does not cause a master piston of a master cylinder device to scrape against a master cylinder.

Briefly, according to the present invention, there is provided a combination of a master cylinder device with a brake booster device of an input rod pulling type. The brake booster device comprises a brake booster whose interior is partitioned by a diaphragm with a piston secured thereto, into a constant pressure chamber and a variable pressure chamber; a valve mechanism operated by a brake pedal for making the variable pressure chamber communicate selectively with the atmosphere and the constant pressure chamber; and a reaction mechanism for transmitting the axial movement of the diaphragm, generated based on the pressure difference between the constant pressure chamber and the variable pressure chamber, from the piston to an output rod. The master cylinder device connected with the brake booster device comprises a master cylinder having a piston rod which generates a braking pressure when pulled by the output rod rearward. The output rod extends as the piston rod in the master cylinder of the master cylinder device. The master cylinder device further comprises engaging means provided at the forward end of the piston rod for engaging a master piston with the piston rod so that the master piston is floatable on the piston rod but restrained from being moved forward relative to the piston rod in the axial direction of the same.

With this configuration, when the valve mechanism is operated by the brake pedal, the atmosphere is led into the variable pressure chamber to move the diaphragm. Thus, the piston secured to the diaphragm is retracted, and the output rod connected to the piston through the reaction mechanism is also retracted. Since the output rod extends as the piston rod in the master cylinder of the master cylinder device, a pressurized braking fluid is delivered from the master cylinder when the piston rod mounting the master piston at the forward end portion thereof is pulled in a direction heading for a passenger room. Since the master piston is mounted on the piston rod to be able to float thereon, the swing or tilting motion of the piston rod can be prevented from being transmitted to the master piston, so that the master piston can move back and forth smoothly without scraping against the master cylinder.

### BRIEF DESCRIPTION OF THE ACCOMPANYING DRAWINGS

The foregoing and other objects and many of the attendant advantages of the present invention may readily be appreciated as the same becomes better understood by reference to the preferred embodiment of the present invention when considered in connection with the accompanying drawings, wherein like reference numerals designate the same or corresponding parts throughout several views, and in which:

FIG. 1 is a longitudinal sectional view of a master cylinder device with a booster device of an input rod pulling type in one embodiment according to the present invention;

FIG. 2 is a fragmentary sectional view showing the forward end portion of a master cylinder closed by a plug member in a modified form of the embodiment; and

FIG. 3 is a fragmentary sectional view showing another form of floating engaging means used in another modified form of the embodiment.

### DETAILED DESCRIPTION OF THE PREFERRED EMBODIMENT

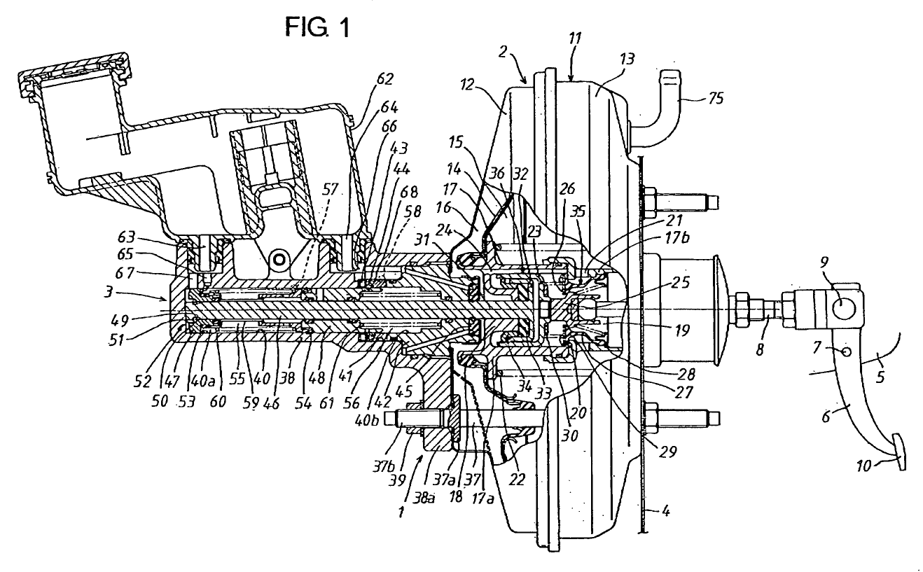

A master cylinder device with a booster device according to the present invention will be described hereinafter with reference to the accompanying drawings. Referring now to FIG. 1, a numeral 1 generally denotes a master cylinder device with a brake booster device of an input rod pulling type which is constituted by combining or connecting a brake booster device 2 with a master cylinder device 3. The combination of the master cylinder device 3 with the brake booster device 2 generally indicated by numeral 1 is fixed to a dashboard (i.e., a partition wall) 4 of a vehicle which separates or compartments a passenger room from an engine room in a motor vehicle. Provided fixedly on the dashboard 4 within the passenger room (i.e., on a surface facing the passenger room of the dashboard 4) is a pedal bracket 5, on which a brake pedal arm 6 is pivotally carried by means of a pivot pin 7 at its middle portion. The brake pedal arm 6 pivotally carries an input rod 8 by means of a connecting pin 9 at its upper end and is provided with a brake pedal 10 at its lower end.

The brake booster device 2 has a front shell 12 and a rear shell 13 which constitutes a booster 11 together. The circumferential portions of these shells 12, 13 put the circumferential edge bead portion of a diaphragm 14 therebetween to secure the bead portion air-tightly and are secured by caulking to each other at several portions in the circumferential direction thereof. Thus, the interior of the booster 11 is partitioned with the diaphragm 14 into a constant pressure chamber 15 and a variable pressure chamber 16. A piston 17 is inserted at its forward end into a center hole of the diaphragm 14 and is secured air-tightly thereto. Thus, the forward end portion of the piston 17 is exposed to the variable pressure chamber 16. The rear end portion of the piston 17 is sealed to isolate the constant pressure chamber 15 from the atmosphere and is projected rearward from the rear shell 13. The rear shell 13 is provided with a negative-pressure leading conduit 75 connected therewith. The constant pressure chamber 15 is in communication with an intake manifold (not shown) through the negative-pressure leading conduit 75, so that the chamber 15 is kept at a negative pressure.

The piston 17 is composed of a first piston portion 17a fixedly inserted into the center hole of the diaphragm 14 and a second piston portion 17b slidably supported by the rear shell 13. The forward end of the second piston portion 17b is fit on the rear end external surface of the first piston portion 17a and is connected bodily therewith by caulking. Thus, the piston 17 takes the shape of a cup having a bottom portion 18 and a valve hole 19. At the connecting portion of the second piston portion 17b with the first piston portion 17a, there is formed a protruding portion which extend circumferentially and radially inwardly. A first valve seat 20 is formed at the end surface of the protruding portion facing the first piston portion 17a. Further, close to the connecting portion of the second piston portion 17b with the first piston portion 17a, there are provided radially extending holes 21 at plural portions in the circumferential direction. A part of the valve hole 19 is in communication with the constant pressure chamber 15 by way of the radially extending holes 21. The piston 17 is urged forwardly by a return spring 22 resting on a flange portion which is formed on the circumference of the axial mid portion of the first piston portion 17a.

A cup-shape connecting member 23 is slidably inserted into the internal surface of the first piston portion 17a. Communication grooves 24 are axially formed on the insertion surface, i.e., the internal surface of the first piston portion 17a, which inserts the connecting member 23 thereinto, and open to the variable pressure chamber 16. An atmospheric valve member 25 is connected to the center of the rear surface of the connecting member 23. The atmospheric valve member 25 passes through the connecting portion of the both piston portions 17a, 17b and extends into the second piston portion 17b to be connected with the forward end of the input rod 8. The atmospheric valve member 23 is formed at its circumference with a flange or protruding portion which protrudes radially outwardly. A second valve seat 26 is formed on the protruding portion to face the first piston portion 17a. Thus, the first valve seat 20 formed on the second piston portion 17b and the second valve seat 26 formed on the atmospheric valve member 25 are radially spaced apart from each other with a clearance therebetween and are in correspondence to each other in their axial positions.

A reference numeral 27 denotes a control valve member for switching the variable pressure chamber 16 into communication with the atmosphere or into communication with the constant pressure chamber 15. The root portion of the control valve member 27 is secured by means of a metal holdfast 28 to the internal surface of the second piston portion 17b. The control valve member 27 is provided with a valve portion 29, which is connected to the root portion through a flexible portion stretchable in the axial direction. The valve portion 29 is plunged inside the first piston portion 17a through the clearance between the first valve seat 20 and the second valve seat 26 and is urged by the resilient force of a compression spring 30 to contact the both valve seats 20, 26. The control valve member 27 partitions the interior of the valve hole 19 into a constant pressure chamber side and an atmosphere side. Thus, with the control valve member 27 being in separation from the first valve seat 20 or from the second valve seat 26, either the constant pressure chamber 15 or the atmosphere is brought into communication with the variable pressure chamber 16 through the communication grooves 24.

A reference numeral 31 denotes an output rod which protrudes ahead of the piston 20. The output rod 31 passes through the bottom portion 18 of the piston 17 and extends into the first piston portion 17a side of the valve hole 19. A receiving portion 32 is formed at the rear end of the output rod 31 and is inserted into the cup-shape connecting member 23 to axially slidable a predetermined amount. An annular reaction member 33 made of rubber or the like is retained between the receiving portion 32 of the output rod 31 and the bottom portion 18 of the piston 17. An annular ring 34 is engaged with the connecting member 23 to put the reaction member 33 between itself and receiving portion 32.

The foregoing first and second valve seats 20, 26, the control valve member 27, the compression spring 30 and the like constitute a valve mechanism 35 for switching the variable pressure chamber 16 into communication with the constant pressure chamber 15 or into communication with the atmosphere. Further, the receiving portion 32 of the output rod 31, the bottom portion 18 of the piston 17, the reaction member 33, the annular ring 34, the connecting member 23 and the like constitute a reaction mechanism 36 for transmitting the movement of the piston 17 to the output rod 31 through the elastic deformation of the reaction member 33 made of rubber or the like and for feeding such movement back to the valve mechanism 35.

The front shell 12 and the rear shell 13 are connected with each other with two tie rods 37, which are arranged in the circumferential direction to extend in parallel relation with the axis of the booster 11 constituted by the both shells. Each tie rod 37 is air-tightly in abutting engagement at a large-diameter mounting seat 37a thereof with the interior surface of the front shell 12 within the variable pressure chamber 16 and is secured to the front shell 12 by deforming by caulking the root portion of the forward end portion 37b which passes through the front shell 12 to extend forward. Each tie rod 37 air-tightly passes through the diaphragm 16 at its mid portion and further air-tightly passes through the rear shell 13 to extend the rear end thereof rearward. The brake booster device 2 is in abutting engagement at its the forward end surface of the front shell 12 with the rear end surface of a flange portion 38a which is formed on a cylinder body 38 of the master cylinder device 3 and is combined or connected with the master cylinder device 3 in such a way that the forward end portion 37b of each tie rod 37 passes through a connection hole formed in the flange portion 38a with a nut 39 being screwed on a male screw formed on the forward end portion 37b.

A cylinder 40a and a fitting hole 41 which constitute a master cylinder 40 are coaxially formed in the cylinder body 38. A small-diameter forward end portion of a cup-shape plug member 42 is fit in the fitting hole 41, with an O-ring sealing the fitting portion therebetween. A ring member 43 and a seal element 44 are interposed between the forward end surface of the plug member 42 and a shoulder portion of the fitting hole 41. The plug member 42 is fixedly screwed at its male screw portion into the fitting hole 41 to be secured to the rear end portion of the cylinder body 38 and is in abutting engagement at its rear shoulder portion with the front shell 12 secured to the rear end surface of the flange portion 38a. The rear end portion of the plug member 42 is protruded rearward beyond the shoulder portion, passing through a center hole of the front shell 12 to enter into the variable pressure chamber 16. The output rod 31 of the brake booster device 2 passes through a rear end bottom portion of the plug member 42 while being sealed with a seal member 45, and extends forward as a piston rod 46 in the master cylinder 40. A cylinder 40b defining the rear end portion of the master cylinder 40 is formed within the small diameter forward end portion of the plug member 42.

First and second master pistons 47, 48 are inserted slidably in the master cylinder 40, and the piston rod 46 is inserted with a play into through holes formed in the first and second master pistons 47, 48. At the forward end portion, the first master piston 47 is co-axially mounted or carried on the piston rod 46 while being prevented from further moving forward in the axial direction and is floatable and tiltable relative to the piston rod 46. That is, a resilient C-washer 50 is fit in an annular groove 49 formed at the forward end portion of the piston rod 46 and is maintained to contact with an bottom surface of an engaging hole 51 which is formed at the forward end surface of the first master piston 47 to be larger in diameter than the through hole, and thus, the piston rod 46 is in engagement at its forward end portion with the forward end portion of the first master piston 47 through the floating-motion engaging means 52 which is constituted by the C-washer 50, the engaging hole 51 and so forth.

A seal element 53 is fit in an annular groove formed on the first master piston 47 to provide a fluid-tight sealing between the external surface of the first master piston 47 and the master cylinder 40. Set on the forward end surface of the second master piston 48 is an annular seal element 54, whose external surface provides a fluid-tight sealing between the external surface of the second master piston 48 and the master cylinder 40 and whose internal surface provides a fluid-tight sealing between the through hole of the second master piston 48 and the external surface of the piston rod 46. Thus, the master cylinder 40 partitions and defines a first cylinder chamber 55 between the first and second master pistons 47, 48. Further, the seal element 44 secured at the forward end surface of the plug member 42 provides a fluid-tight sealing between the external surface of the second master piston 48 and the master cylinder 40, and thus, the master cylinder 40 also partitions and defines a second cylinder chamber 56 between the second master piston 48 and the bottom surface of the plug member 42. The first cylinder chamber 55 is in fluid communication with a first brake system (not shown) through a port 57, while the second cylinder chamber 56 is in fluid communication with a second brake system (not shown) through another port 58. Further, between the first and second master pistons 47, 48, there are interposed a pair of spring seats (not numbered), which are accessible to each other with the largest distance therebetween being limited by a telescopic mechanism 59. And, a compression spring 60 preliminarily compressed is interposed between the pair of spring seats. The preliminary compression force of the compression spring 60 is set larger than the preliminary compression force of another compression spring 61 which is interposed between the second master piston 48 and the plug member 42, so that the second master piston 48 is kept stopped at a neutral position when in the inoperative state.

On the top of the cylinder body 38, a reservoir 62 is mounted fixed by means of a pin (not numbered). First and second outlet ports 63, 64 opened at the lower surface of the reservoir 62 communicate respectively with first and second replenishing ports 65, 66 which open at the top of the cylinder body 38 for replenishing the operating fluid to the first and second cylinder chambers 55, 56. The first replenishing port 65 opens to a shoulder portion of the first master piston 47 positioned at an original or inoperative position and is to be closed by means of the seal element 53 when the first master piston 47 is slid. The space between the first master piston 47 and the forward end of the master cylinder 40 is kept opened to the reservoir 62 through a hole 67 formed in the cylinder body 38. The seal element 53 is held on the shoulder portion of the first master piston 47 to be slid bodily with the same. The second replenishing port 66 communicates with a groove which is radially provided at a surface abutting on the seal element 44 of the ring member 43. This groove in turn communicates with a replenishing hole 68 which is radially provided in an annular portion of the second master piston 48, when the same is positioned at an original or inoperative position. The communication of the groove with the replenishing hole 68 is shut off when the second master piston 48 is slid to depart from the inoperative position.

(Operation)

The operation of the embodiment as constructed above will be described hereinafter. When the brake pedal 10 is stepped on thereby to pull the input rod 8 toward right as viewed in FIG. 1, the annular ring 34 engaged with the connecting member 23 is moved toward right against the compression spring 30 as it compresses the reaction member 33. This causes the valve member 29 of the control valve 27 to depart from the second valve seat 26 of the atmospheric valve member 25. Thus, the atmosphere in the passenger room is flown into the variable pressure chamber 16 through the second valve seat 26 and the communication grooves 24. This causes the pressure difference to occur between the variable pressure chamber 16 and the constant pressure chamber 15, whereby the diaphragm 14 and the piston 17 are moved rearward against the resilient force of the return spring 22.

With the rearward movement of the piston 17, the receiving portion 32 of the output rod 31 is retracted as urged by the reaction member 33, and the output rod 31 is thus pulled to operate as the piston rod 46 in the master cylinder 40. Therefore, the first master piston 47 in the master cylinder 40 is moved rearward through the engaging means 52 thereby to close the first replenishing port 65 with the seal element 53. After the first replenishing port 65 is closed, the rear-ward movement of the first master piston 47 causes the operating fluid to be pressurized within the first cylinder chamber 55, and the pressurized brake fluid is supplied to the first brake system (not shown) through the port 57.

Herein, the first master piston 47 is engaged by the floating-motion engaging means 52 with the piston rod 46. Thus, even when the output rod 31 swings or tilts as the piston 17 is retracted, such swing or tilting motion can be prevented from being transmitted from the piston rod 46 to the first master piston 47, so that the first master piston 47 can be moved back and forth smoothly without scraping or damaging the master cylinder 40, i.e., the internal surface guiding the first master piston 47.

Since the pressure of the braking fluid (i.e., operating fluid) in the first cylinder chamber 55 is increased with the rearward movement of the first master piston 47, the second master piston 48 is moved rearward as it compresses the compression spring 61. Thus, the replenishing hole 68 is shut off with the seal element 44 to be disconnected from the second replenishing port 66. After the second replenishing port 66 is closed, the rearward movement of the second master piston 48 causes the operating fluid (i.e., braking fluid) to be pressurized within the second cylinder chamber 56, and the pressurized operating fluid is supplied to the second brake system (not shown) through the port 58, The second master piston 48 is balanced at the position where it makes the first and second cylinder chambers 55, 56 have the same pressure.

On the other hand, the piston 17 is moved rearward in dependence on the pressure difference across the diaphragm 14 and at the same time, moves the first master piston 47 through the output rod 31 as it resiliently deforms the reaction member 33. The valve member 29 of the control valve member 27 is retracted relative to the atmospheric valve member 25. Therefore, when the piston 17 pulls the output rod 31 with the operating force which coincides with the stepping force on the brake pedal 10, the valve member 29 of the control valve member 27 is brought into contact with the second valve seat 26 thereby to cut off the communication of the variable pressure chamber 16 with the atmosphere, so that the hydraulic brake pressure can be sustained at a magnitude as desired. At this time, the force with which the brake pedal 10 is stepped on is transmitted through the input rod 8 to the connecting member 23 and then, from the annular ring 34 of the same to the reaction member 33. Therefore, the reaction member 33 is elastically deformed in dependence on the pedal stepping force, so that the driver can feel the reaction force.

When the brake pedal 10 is released, the elastic restoration capability of the reaction member 33 causes the connecting member 23 to move relative to the piston 17 thereby to separate the valve member 29 of the control valve member 27 from the first valve seat 20. Thus, the negative pressure in the constant pressure chamber 15 is led to the variable pressure chamber 16 through the radial holes 21, the first valve seat 20 and the communication grooves 24 to make zero the pressure difference between the variable pressure chamber 16 and the constant pressure chamber 15. Therefore, the piston 17 and the diaphragm 14 are moved forward by the resilient force of the return spring 22 to be returned to the original position. With the forward movement of the piston 17, on the other hand, the first and second master pistons 47, 48 of the master cylinder 40 are returned to their respective original or inoperative positions, whereby the first and second cylinder chambers 55, 56 of the master cylinder 40 are made again open to the reservoir 62.

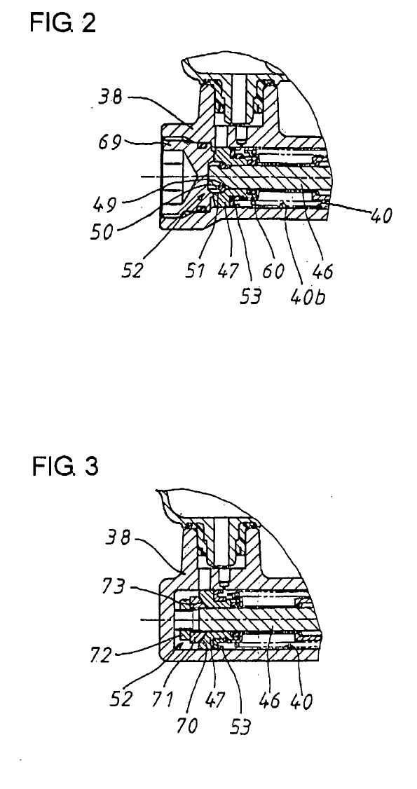

Although in the foregoing embodiment, the master cylinder 40 is constituted by forming the cylinder body 40a to have a closed end surface at the forward end, it may otherwise be constituted as shown in FIG. 2 by forming a forward opening cylinder 40b in the cylinder body 38 and then by closing the forward end of the cylinder 40b with a plug member 69 for selective opening or closing. With this modified construction, part assembling becomes easy since the plug member 69 can be disassembled, in which state the first master piston 47 is assembled on the forward end portion of the piston rod 46 with a play therebetween and the C-washer 50 is fit in the annular groove 49.

The floating-motion engaging means 52 may be modified as shown in FIG. 3. That is, an engaging member 71 with an engaging spherical surface 70 at the rear end is secured with a nut 72 on the forward end of the piston rod 46, and a complementary spherical or cone seat 73 which is engageable with the engaging spherical surface 70 is engraved on the forward end surface of the first master piston 47.

Finally, various features and many of the attendant advantages in the foregoing embodiments will be summarized as follows:

In the embodiment shown in FIG. 1, when the valve mechanism 35 is operated by the brake pedal 10, the atmosphere is lead into the variable pressure chamber 16 to move the diaphragm 14. Thus, the piston 17 secured to the diaphragm 14 is retracted, and the output rod 31 connected to the piston 17 through the reaction mechanism 36 is also retracted. Since the output rod 31 extends as the piston rod 46 in the master cylinder 40 of the master cylinder device 3, a pressurized braking fluid is delivered from the master cylinder 40 when the piston rod 46 mounting the master piston 47 at the forward end portion thereof is pulled in a direction heading for a passenger room. Since the master piston 47 is mounted on the piston rod 46 to be able to float relative thereto, the swing or tilting motion of the piston rod 46 can be prevented from being transmitted to the master piston 47, so that the master piston 47 can move back and forth smoothly without scraping against the master cylinder 40.

Also in the embodiment shown in FIG. 1, the piston 17 secured to the diaphragm 14 takes the cup shape having the bottom portion 18 and the valve hole 19, and the output rod 31 faces the bottom portion 18 of the piston 17 at the receiving portion 32 which is formed at the rear end passing through the bottom portion 18 of the piston 17. This enables the bottom portion 18 and the receiving portion 32 to hold the reaction member 33 of the reaction mechanism 36 therebetween. Therefore, it becomes possible to make the output rod 31 act on the reaction mechanism 36 through the simplified construction and to make the output rod 31 extend as the piston rod 46 in the master cylinder 40.

Also in the first embodiment shown in FIG. 1, the output rod 31 fluid-tightly passes through the second and first master pistons 48, 47 of the master cylinder device 3 to extend forward as the piston rod 46 and is engaged at its forward end portion with the first master piston 47 to make the same floatable relative thereto. Therefore, it becomes realized in the tandem master cylinder to mount the first master piston 47 on the forward end portion of the piston rod 46 to be floatable thereon through the simplified construction.

Obviously, numerous modifications and variations of the present invention are possible in light of the above teachings. It is therefore to be understood that within the scope of the appended claims, the present invention may be practiced otherwise than as specifically described herein.

What is claimed is:

1. A combination of a master cylinder device with a brake booster device of an input rod pulling type wherein said brake booster device comprises:
a brake booster whose interior is partitioned by a diaphragm with a piston secured thereto, into a constant pressure chamber and a variable pressure chamber;
a valve mechanism operated by a brake pedal for making said variable pressure chamber communicate selectively with the atmosphere and said constant pressure chamber: and
a reaction mechanism for transmitting the axial movement of said diaphragm generated based on the pressure difference between said constant pressure chamber and said variable pressure chamber, from said piston to an output rod; and wherein said master cylinder device connected with said brake booster device comprises:
a master cylinder having a piston rod for generating a braking pressure when pulled by said output rod rearward, said output rod extending as said piston rod in said master cylinder of said master cylinder device; and
floating-motion engaging means provided at the forward end of said piston rod for engaging a first master piston with said piston rod so that said first master piston is floatable relative to said piston rod but restrained from being moved forward relative to said piston rod in the axial direction of the same.

2. The combination as set forth in claim 1, wherein:
said piston of said brake booster device take the form of a cup having a bottom portion and a valve hole;
said output rod passes through said bottom portion and has a receiving portion formed in said valve hole; and
a reaction member of said reaction mechanism is interposed between said receiving portion of said output rod and said bottom portion of said piston of said brake booster device.

3. The combination as set forth in claim 1, wherein:
said output rod fluid-tightly passes through a second master piston and said first master piston of said master cylinder device to extend forward as said piston rod; and
said piston rod is engaged at its forward end portion with the forward end of said first master piston through said floating-motion engaging means.

4. The combination as set forth in claim 2, wherein:
said output rod fluid-tightly passes through a second master piston and said first master piston of said master cylinder device to extend forward as said piston rod; and
said piston rod is engaged at its forward end portion with the forward end of said first master piston through said floating-motion engaging means.

5. The combination as set forth in claim 1, wherein said piston of said brake booster device is constituted by bodily connecting a first piston portion incorporating said reaction mechanism for transmitting the movement of said piston through a reaction member to said output rod, with a second piston portion opening to a passenger room at one end thereof.

6. The combination as set forth in claim 2, wherein said piston of said brake booster device is constituted by bodily connecting a first piston portion incorporating said reaction mechanism for transmitting the movement of said piston through a reaction member to said output rod, with a second piston portion opening to a passenger room at one end thereof.

7. The combination as set forth in claim 3, wherein said piston of said brake booster device is constituted by bodily connecting a first piston portion incorporating said reaction mechanism for transmitting the movement of said piston through a reaction member to said output rod, with a second piston portion opening to a passenger room at one end thereof.
